(19) United States
(12) Patent Application Publication
(10) Pub. No.: US 2014/0306534 A1
(43) Pub. Date: Oct. 16, 2014

(54) PMU BASED DISTRIBUTED GENERATION CONTROL FOR MICROGRID DURING ISLANDING PROCESS

(71) Applicant: NEC Laboratories America, Inc., Princeton, NJ (US)

(72) Inventors: Di Shi, San Jose, CA (US); Ratnesh Sharma, Fremont, CA (US)

(73) Assignee: NEC Laboratories America, Inc., Princeton, NJ (US)

(21) Appl. No.: 14/243,275

(22) Filed: Apr. 2, 2014

Related U.S. Application Data
(60) Provisional application No. 61/812,228, filed on Apr. 15, 2013.

(51) Int. Cl. H02J 4/00

(52) U.S. Cl. CPC H02J 4/00
USPC 307/52

(57) ABSTRACT

A method for voltage regulation of a power distribution grid includes integrating a photovoltaic (PV) system with a distributed energy storage system (ESS); monitoring voltage and current phasors at a point of common coupling (PCC) to establish a real-time Thevenin equivalent of the distribution grid; and adaptively dispatching the ESS in response to network fluctuations.

This application is a utility conversion and claims priority to Provisional Application Ser. No. 61/812,228 filed Apr. 15, 2014, the content of which is incorporated by reference.

### BACKGROUND

The present invention relates to microgrid control.

Penetration of renewable energy sources (RESs) in power systems has been increasing dramatically during the last few years. Solar photovoltaic (PV) system is the most commonly observed form of RESs in the low-voltage distribution system. Nonetheless, the negative impact of PV grid integration has drawn concerns from researchers around the world. Traditionally, distribution systems were designed to operate in radial configuration with a single power source at substation. Power flows in a single direction from substation to the remote end and voltage level drops along the distribution feeder. However, with high penetration of PV generation, power flow and voltage profiles in distribution system will change significantly. When PV generation substantially exceeds local load at the point of common coupling (PCC), surplus power from PV will flow back to the grid and produce reverse power flows, which may cause the well-known voltage rise problem. Further, due to high variability of solar energy availability (e.g., cloud transient effect), PV generation can fluctuate at very high ramping rate, leading to severe power quality and even voltage stability issues. The aforementioned voltage problems make it difficult for the distribution utilities to operate their feeders without violating the voltage limits stipulated by local standards. Therefore, solution needs to be developed so that targeted PV penetration level can be achieved while the system operating limits are complied.

Several methods have been proposed in the past to tackle the voltage issues caused by PV. One method uses active power curtailment to eliminate the voltage-rise problem. Active power curtailment is not attractive from economic point of view. In addition, it requires the prediction of the voltage profiles and prior knowledge of some compensation factors/parameters, which are difficult to acquire. In another method, reactive power support was also proposed to mitigate the voltage-rise problem. Basically, this kind of methods requires very expensive and over-sized inverters and therefore is not common practice for small PV units in distribution system. Currently, based on the IEEE standards, dynamic variable control is not allowed for PV inverters. In a third method, using active network management, researchers have shown the possibility of voltage control through some coordination and communication. These methods assume the availability of widespread communication infrastructure. Yet another approach integrates energy storage devices with residential PV system. In these methods, storage devices are charged at noon time to store the surplus power from PV to reduce the reverse power flow. The stored energy is used to support the voltage by serving the local load during the evening peak. These methods consider an over-simplified charge/discharge pattern by assuming no voltage problem will occur except during the noon time and evening peak. However, if load pattern changes, for example, during holidays, application of such schemes might be detrimental for the distribution system.

### SUMMARY

In one aspect, a method for voltage regulation of a power distribution grid includes integrating a photovoltaic (PV) system with a distributed energy storage system (ESS); monitoring voltage and current phasors at thepoint of common coupling (PCC) to establish a real-time Thevenin equivalent of the distribution grid; and adaptively dispatching the ESS in response to network fluctuations.

Advantages of the preferred embodiments may include one or more of the following. The system requires very simple system setup and therefore the distribution system voltage regulation becomes less expensive. The control strategy is simple and highly reliable since no offline study and no manual operation is needed. It reduces the need for system maintenance as well as the possibility of equipment failure, greatly reducing the cost for the customers. The system identifies possible voltage violation in advance. Additionally, the system identifies the amount of power at which ESS should be dispatched to prevent the voltage violation.

### BRIEF DESCRIPTION OF THE DRAWINGS

FIG. 1 shows the diagram of a distribution system with PV and ESS integrated at PCC.

FIG. 2 shows a Thevenin equivalent of the distribution system.

FIG. 3 shows an exemplary control strategy for the ESS.

FIG. 4 shows an exemplary system C1 for Adaptive Control of Energy Storage System (ESS) for Voltage Regulation.

FIG. 5 shows an exemplary system running the control strategy of FIG. 3.

### DESCRIPTION

In this invention, a novel framework for distribution network voltage regulation is proposed by integrating PV system with distributed energy storage system (ESS) and adaptively dispatching the ESS. In the proposed framework, the voltage and current phasors at the point of common coupling (PCC) are continuously monitored to establish a real-time Thevenin equivalent of the distribution grid. Based on this equivalent, the maximum and minimum power injections allowed at PCC are continuously tracked. When voltage violation occurs, control signals are sent to the ESS to dynamically adjust its charging/discharging so that voltage can be restored to acceptable values based on the IEEE standard. The system will also mitigate the detrimental effects of sudden change in PV output.

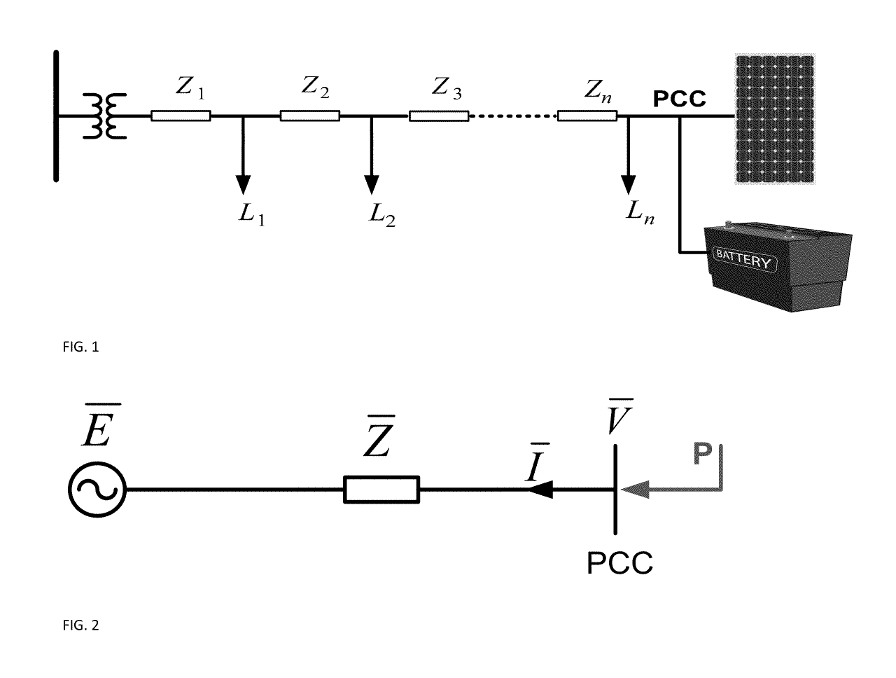

The basic idea for voltage regulation is to control the power injection at point of PCC by integrating ESS with the PV array. FIG. 1 shows the diagram of a distribution system with PV and ESS integrated at PCC. Looking back from PCC, a distribution system can be represented by a Thevenin equivalent as shown in FIG. 2.

As FIG. 2 shows, E is a complex number representing voltage of the equivalent source; Z̅ (complex) is the equivalent impedance; V̅ (complex) is the voltage phasor at PCC; Ī (complex) and P are current phasor and active power injection from the PV and ESS, respectively. It should be noted that these variables are constantly changing as system operating condition varies. The following equation can be written:

V̅= E̅+ Z̅· I̅ (1)

Define the following:

Ē=E<δ=E_{R}+j·Eⱼ (2)

V̅=V<θ_{V}=V_{R}+j·V_{I} (3)

Z̅=R+j·X (4)

Ī=I<θ₁=I_{R}+j·Iₓ (5)

where j=\sqrt{−1}.

Equation (1) can be broken up into two real equations, which, in matrix format are shown as (6):

$$[ \begin{matrix}{V}_{R} \\ {V}_{I}\end{matrix} ] = [ \begin{matrix}1 & 0 & {I}_{R} & - {I}_{I} \\ 0 & 1 & {I}_{I} & {I}_{R}\end{matrix} ] \cdot [ \begin{matrix}{E}_{R} \\ {E}_{I} \\ R \\ X\end{matrix} ] \qquad ( 6 )$$

Voltage and current injection at PCC can be measured and processed in real time by Discrete Fourier Transform (DFT) to obtain the corresponding phasors. Therefore, V_{R}, V_{I}, I_{R} and Iᵢ are considered as known variables while E_{R}, R_{I}, and X are parameters to estimate. To solve two equations with four unknowns, at least two measurement points are needed. In this work, a sliding window containing four measurement points is used for the parameter estimation.

The Kalman filter is an optimal state estimator for dynamical systems. It estimate the system unknown states efficiently in a recursive way. A general discrete state-space representation of a dynamic system is shown in (7)-(8):

xₖ₊₁=Aₖxₖ+wₖ (7)

zₖ=Hₖxₖ+vₖ (8)

where xₖ is the state vector; Aₖ is the state transition matrix; zₖ is the measurement vector; Hₖ is the observation matrix; wₖ and vₖ are the process noise and measurement noise, respectively.

Noise wₖ and vₖ are assumed to be independent of each other and their covariance matrixes are given by (9) and (10):

E(wₖwₖ^{T})=Rₖ (9)

E(vₖvₖ^{T})=Qₖ (10)

For this particular parameter estimation problem, the vectors/matrixes used in equation (7) and (8) are defined as follows:

$$\begin{matrix}{x}_{k} = {[ \begin{matrix}{E}_{R}^{k} \\ {E}_{I}^{k} \\ {R}_{k} \\ {X}_{k}\end{matrix} ]}_{4 \times 1} & ( 11 ) \\ {z}_{k} = {[ \begin{matrix}{V}_{R}^{k 1} \\ {V}_{I}^{k 1} \\ ⋮ \\ {V}_{R}^{k 4} \\ {V}_{I}^{k 4}\end{matrix} ]}_{8 \times 1} & ( 12 ) \\ {A}_{k} = {[ \begin{matrix}1 & & & \\ & 1 & & \\ & & 1 & \\ & & & 1\end{matrix} ]}_{4 \times 4} & ( 13 ) \\ {H}_{k} = {[ \begin{matrix}1 & 0 & {I}_{R}^{k 1} & - {I}_{I}^{k 1} \\ 0 & 1 & {I}_{I}^{k 1} & {I}_{R}^{k 1} \\ ⋮ & ⋮ & ⋮ & ⋮ \\ 1 & 0 & {I}_{R}^{k 4} & - {I}_{I}^{k 4} \\ 0 & 1 & {I}_{I}^{k 4} & {I}_{R}^{k 4}\end{matrix} ]}_{8 \times 4} & ( 14 )\end{matrix}$$

where (.)^{k} refers to the unknown parameters at the k th time step (window); (.)^{ki} refers to the ith measurement point at the kth time step (window).

The unknown parameters at each time instant can be calculated using the following set of recursive equations (15)-(18):

Pₖ₊₁=Aₖ₊₁PₖAₖ₊₁^{T}+Qₖ (15)

Kₖ₊₁=Pₖ₊₁Hₖ₊₁^{T}Hₖ₊₁Pₖ₊₁Hₖ₊₁^{T}+Rₖ₊₁]⁻¹ (16)

xₖ₊₁=Aₖ₊₁+Kₖ₊₁[zₖ₊₁−Hₖ₊₁Aₖxₖ] (17)

Pₖ₊₁=Pₖ₊₁−Kₖ₊₁Hₖ₊₁Pₖ₊₁ (18)

where Kₖ is the Kalman gain at time step k.

A. Maximum/Minimum Power Injection

After calculating the parameters of the Thevenin equivalent for the distribution network, the next step is to estimate the maximum allowed power injection at the PCC. Since both ESS and PV are working at unity power factor, only active power is injected at PCC, based on which the following equation can be derived according to (3) and (5):

θᵢ=θ_{V} (19)

and

P=VI cos(θ_{V}−θ_{I})=VI (20)

From (1), it is noted that the larger the current (power) injection is, the greater the voltage at PCC is and vice versa. When voltage at PCC reaches its upper/lower limit, the corresponding current (power) injection will also reach the maximum/minimum. The upper/lower limits of the voltage Vₗᵢₘ, can be obtained from IEEE standards or from the requirements of the specific application. To calculate the maximum/minimum power injection Pₗᵢₘ, at PCC, the following equation can be derived based on (1), (19) and (20):

$${V}_{lim} {∠θ}_{V} = E ∠ δ + ( R + j X ) \frac{{P}_{lim}}{{V}_{lim}} {∠θ}_{V} ⇒ ( {V}_{lim} - \frac{{RP}_{lim}}{{V}_{lim}} - j \frac{{XP}_{lim}}{{V}_{lim}} ) ∠θ = E ∠ δ \qquad ( 21 )$$

Take Euclidean norm for both sides of the equation and collect terms to get:

(R²+X²)Pₗᵢₘ²−2RVₗᵢₘ²Pₗᵢₘ+Vₗᵢₘ²(Vₗᵢₘ²−E²)=0 (22)

Solution of equation (22) can be found to be:

$${P}_{lim} = \frac{{RV}_{lim}^{2} + {V}_{lim} \sqrt{( {R}^{2} + {X}^{2} ) {E}^{2} - {X}^{2} {V}_{lim}^{2}}}{{R}^{2} + {X}^{2}} \qquad ( 23 )$$

B. Proposed Control Strategy

After evaluating the maximum power injection allowed at PCC, the voltage violation margin can be defined as the difference between the power injection limits and the actual power injection:

P_{m arg}_{_{—}}ᵤₚₚₑᵣ=Pₗᵢₘ_{_{—}}ᵤₚₚₑᵣ−P_{actual} (24)

P_{marg}_{_{—}}_{lower}=P_{actual}−Pₗᵢₘ_{_{—}}_{lower} (25)

where P_{marg}_{_{—}}ᵤₚₚₑᵣ and P_{marg}_{_{—}}_{lower} are the upper and lower margins of the power injection; P_{hd lim}_{_{—}}ᵤₚₚₑᵣ and Pₗᵢₘ_{_{—}}_{lower} are the upper and lower bounds of the power injection; P_{actual} is the actual power injection calculated by the measured voltage and current at PCC.

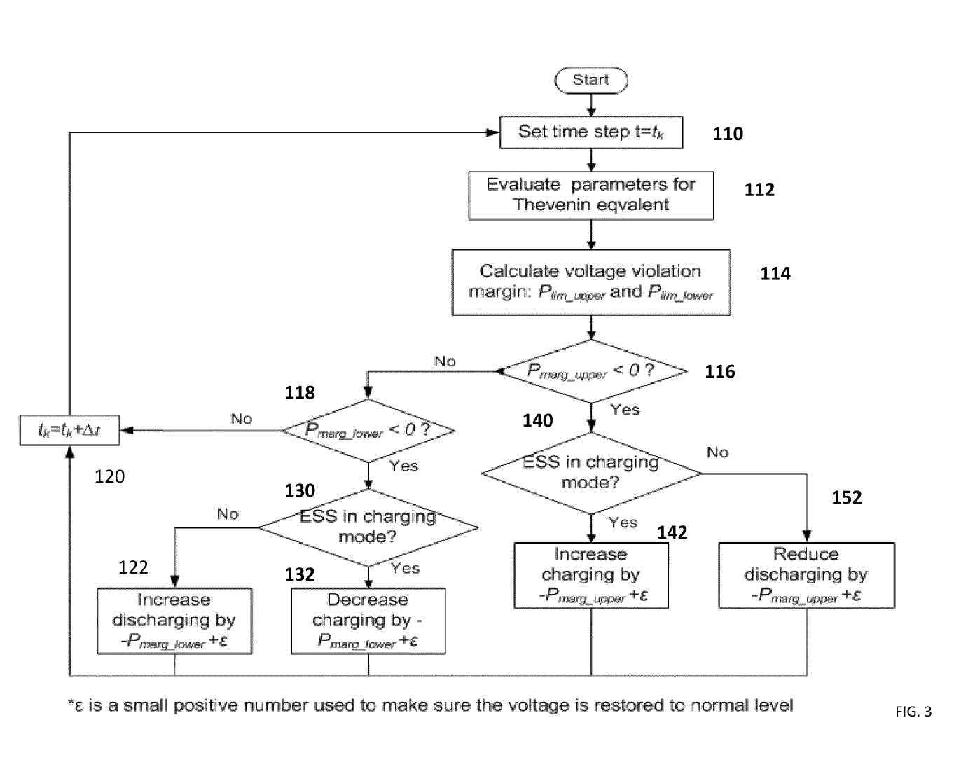

The control strategy for the ESS is shown in FIG. 3.Turning now to FIG. 3, an exemplary control process is disclosed. Upon entry, the process sets a time step value t (110). Next, the process evaluates parameters for determining Thevenin equivalency (112). The process calculates a voltage deviation margin (114), and then determines if an upper margin is negative (116).

If the upper margin is not negative, the process checks if the lower margin is negative (118), and if not the process increments the time step (120) and loops back to 110. Otherwise, the process checks if the ESS is in a charging mode (130). If not, the process increases energy discharging by a predetermined amount (122) and otherwise the process decreases energy charging by the predetermined amount (132).

From 116, if the upper margin is zero or positive, the process checks if the ESS is in a charging mode (140) and if so the process increases the charging by the predetermined amount (142) and otherwise reduces discharging by the predetermined amount.

The framework for distribution network voltage regulation operates by integrating PV system with distributed energy storage system (ESS) and adaptively dispatching the ESS. In the framework, the voltage and current phasors at the point of common coupling (PCC) are continuously monitored to establish a real-time Thevenin equivalent of the distribution grid. Based on this equivalent, the maximum and minimum power injections allowed at PCC are continuously tracked. The voltage violation margins at PCC are calculated and the ESS is controlled adaptively to prevent the occurrence of voltage violation. The method can also be used to mitigate the detrimental effects of sudden change in PV output. The system has been tested on a typical US distribution system and its effectiveness is demonstrated through simulations.

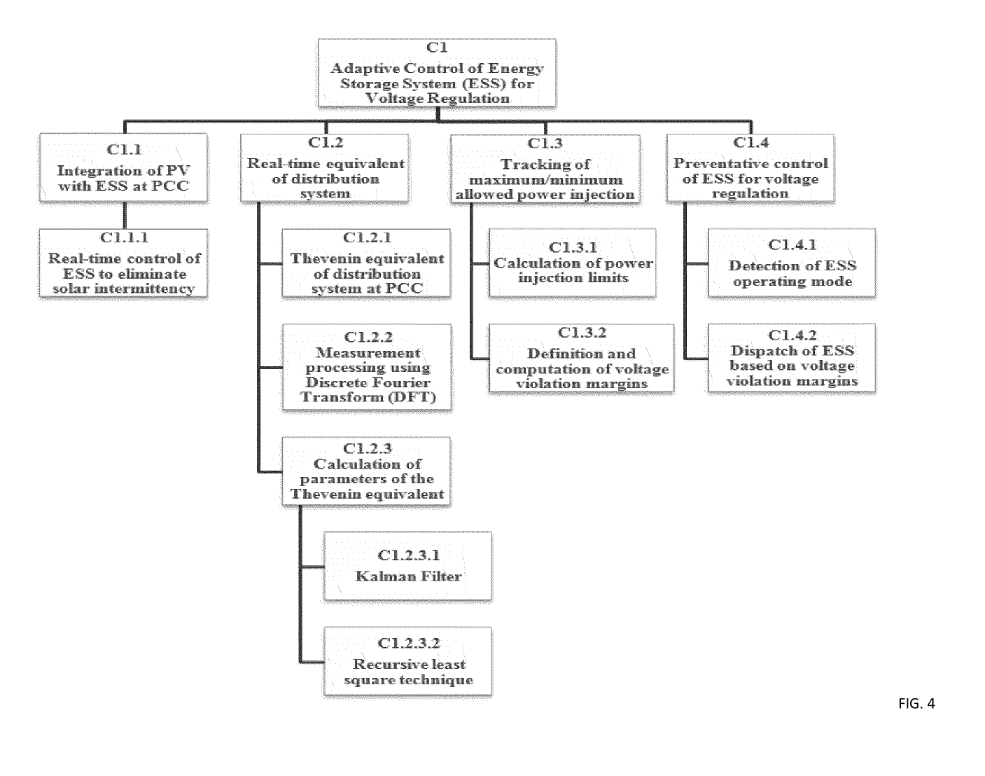

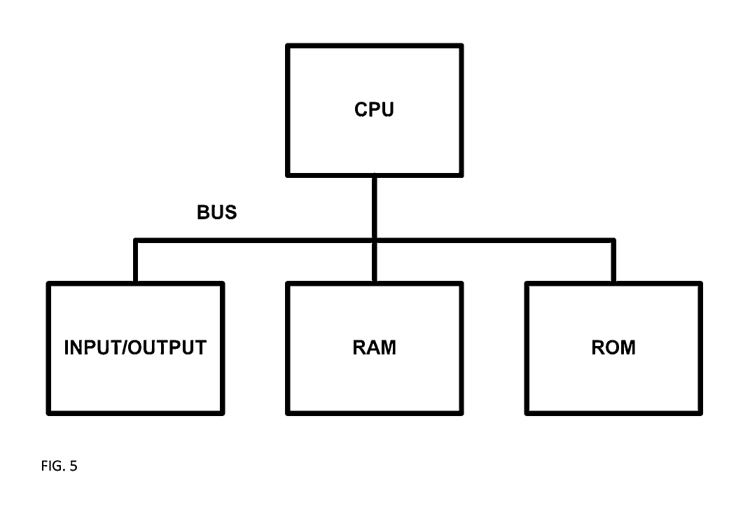

FIG. 4 shows an exemplary system C1 for Adaptive Control of Energy Storage System (ESS) for Voltage Regulation. The system has the following major modules with the following functions:
C1.1—Integration of PV with ESS at PCC
   C1.1.1—Real-time control of ESS to eliminate solar intermittency
C1.2—Real-time equivalent of distribution system
   C1.2.1—Thevenin equivalent of distribution system at PCC
C1.2.2—Measurement processing using Discrete Fourier Transform (DFT)
C1.2.3—Calculation of parameters of the Thevenin equivalent
   Kalman Filter
   Recursive least square technique
C1.3—Tracking of maximum/minimum allowed power injection
   Calculation of power injection limits
   Definition and computation of voltage violation margins
C1.4—Preventative control of ESS for voltage regulation
   Detection of ESS operating mode
   Dispatch of ESS based on voltage violation margins

The system effectively integrates the energy storage system (ESS) with PV with a preventive control framework for distribution network voltage regulation through adaptive control of ESS charge/discharge. In the framework, voltage and current at the point of common coupling (PCC) are continuously monitored to establish a real-time equivalent circuit of the distribution network. Based on this equivalent, the maximum and minimum power injections allowed at PCC are continuously tracked. The proposed scheme solves two issues:
Identify possible voltage violation in advance.
Identify amount of power at which ESS should be dispatched to prevent the voltage violation.

In this framework, charge and discharge of the ESS is adjusted adaptively to prevent the voltage at PCC from violating the pre-defined limits. The proposed method can be used to eliminate the voltage-rise problem caused by reverse power flow, and it can also be used to mitigate the detrimental effects of abrupt change/fluctuation in PV output.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for voltage regulation of a power distribution grid, comprising:
integrating a photovoltaic (PV) system with a distributed energy storage system (ESS);
monitoring voltage and current phasors at a point of common coupling (PCC) to establish a real-time Thevenin equivalent of the distribution grid; and
adaptively dispatching the ESS in response to network fluctuations.

2. The method of claim 1, comprising performing preventative control of ESS for voltage regulation by detection of ESS operating mode and dispatching the ESS based on voltage violation margins.

3. The method of claim 2, comprising tracking maximum and minimum power injections allowed at the PCC based on the equivalent.

4. The method of claim 1, comprising sending control signals to the ESS to dynamically adjust its charging or discharging to restore voltage to acceptable values when voltage violation occurs.

5. The method of claim 4, wherein the control signals are based on an IEEE standard.

6. The method of claim 1, comprising determining a real-time equivalent of the distribution grid.

7. The method of claim 6, comprising determiningThevenin equivalent of distribution system at PCC.

8. The method of claim 6, comprising performing measurement processing using Discrete Fourier Transform (DFT).

9. The method of claim 6, comprising determining parameters of the Thevenin equivalent with a KalmanFilter or a recursive least square technique.

10. The method of claim 1, comprising tracking of maximum/minimum allowed power injection by calculation of power injection limits and determining voltage violation margins.

11. A method for distribution network voltage regulation of a distribution grid, comprising:
integrating a photovoltaic (PV) system with a distributed energy storage system (ESS);
monitoring voltage and current phasors at a point of common coupling (PCC) to establish a real-time Thevenin equivalent of the distribution grid; and
adaptively dispatching the ESS in response to network fluctuations.

12. The system of claim 11, comprising computer code for performing preventative control of ESS for voltage regulation by detection of ESS operating mode and dispatching the ESS based on voltage violation margins.

13. The system of claim 12, comprising computer code for tracking maximum and minimum power injections allowed at the PCC based on the equivalent.

14. The system of claim 11, comprising computer code for sending control signals to the ESS to dynamically adjust its charging or discharging to restore voltage to acceptable values when voltage violation occurs.

15. The system of claim 14, wherein the control signals are based on an IEEE standard.

16. The system of claim 11, comprising computer code for determining a real-time equivalent of the distribution grid.

17. The system of claim 16, comprising computer code for determining Thevenin equivalent of distribution system at PCC.

18. The system of claim 16, comprising computer code for performing measurement processing using Discrete Fourier Transform (DFT).

19. The system of claim 16, comprising computer code for determining parameters of the Thevenin equivalent with a Kalman Filter or a recursive least square technique.

20. The system of claim 11, comprising computer code for tracking of maximum/minimum allowed power injection by calculation of power injection limits and determining voltage violation margins.
